(19) United States
(12) Patent Application Publication
(10) Pub. No.: US 2024/0386062 A1
(43) Pub. Date: Nov. 21, 2024

(54) Label Extraction and Recommendation Based on Data Asset Metadata

(71) Applicant: SAP SE, Walldorf (DE)

(72) Inventors: Jingtao Li, Xi'an (CN); Ming Yan, Xi'an (CN); Jian Song, Xi'an (CN); Jingyuan Li, Xi'an (CN); Siang Luo, Xi'an (CN); Yunze Du, Xi'an (CN)

(21) Appl. No.: 18/318,124

(22) Filed: May 16, 2023

(51) Int. Cl. G06F 16/93; G06F 16/903; G06F 16/906

(52) U.S. Cl. CPC G06F 16/93; G06F 16/90344; G06F 16/906

(57) ABSTRACT

Data assets are labeled based upon a combination of multiple keyword extraction procedures. A data corpus comprises a first document including a data asset and first metadata. The data corpus further comprises a second document including second metadata. A first keyword extraction procedure (e.g., based upon Term Frequency-Inverse Document Frequency) is performed upon the first metadata and the second metadata to determine a first set of candidate words for the data asset. A second, different keyword extraction procedure is performed upon the first metadata to determine a second set of candidate words for the data asset. Based upon a merger approach, the data asset is labeled with a keyword appearing in both the first set of candidate words and the second set of candidate words. A label recommendation is provided for keywords appearing in only one of the first set of candidate words or the second set of candidate words.

### BACKGROUND

Unless otherwise indicated herein, the approaches described in this section are not prior art to the claims in this application and are not admitted to be prior art by inclusion in this section.

In the process of enterprise data governance, the labeling of data assets is an important part of metadata management. The data asset label can play a key role in accurate and efficient data retrieval, data recommendation, and data classification.

Data assets may be manually labeled through human effort. However, such approaches involve high cost and can introduce variation into the labeling process.

### SUMMARY

Embodiments relate to labeling of data assets based upon a combination of multiple keyword extraction procedures. A data corpus comprises a first document including a data asset and first metadata. The data corpus further comprises a second document including second metadata. A first keyword extraction procedure is performed upon the first metadata and the second metadata to determine a first set of candidate words for the data asset label. A second, different keyword extraction procedure is performed upon the first metadata to determine a second set of candidate words for the data asset label. Based upon a merger approach, the data asset is labeled with a keyword appearing in both the first set of candidate words and the second set of candidate words. A recommendation to label the data asset is provided for keywords appearing in only one of the first set of candidate words or the second set of candidate words. In specific embodiments, the first keyword extraction procedure utilizes Term Frequency-Inverse Document Frequency (TF-IDF).

The following detailed description and accompanying drawings provide a better understanding of the nature and advantages of various embodiments.

### BRIEF DESCRIPTION OF THE DRAWINGS

FIG. 1 shows a simplified diagram of a system according to an embodiment.

FIG. 2 shows a simplified flow diagram of a method according to an embodiment.

FIG. 3 shows a simplified flow diagram of data asset labeling according to an example embodiment.

FIG. 4 is a flow diagram showing details of a first procedure in the example.

FIG. 5 is a flow diagram showing details of a second procedure in the example.

FIG. 6 shows sample metadata that may be referenced to perform labeling according to the example.

FIG. 7 shows Term Frequency-Inverse Document Frequency values according to first procedure in the example.

FIG. 8 shows weighted Term Frequency-Inverse Document Frequency values according to the first procedure in the example.

FIG. 9 shows values according to the second procedure in the example.

FIG. 10 illustrates hardware of a special purpose computing machine configured to implement data asset labeling according to an embodiment.

FIG. 11 illustrates an example computer system.

### DETAILED DESCRIPTION

Described herein are methods and apparatuses that implement labeling of data assets. In the following description, for purposes of explanation, numerous examples and specific details are set forth in order to provide a thorough understanding of embodiments according to the present invention. It will be evident, however, to one skilled in the art that embodiments as defined by the claims may include some or all of the features in these examples alone or in combination with other features described below, and may further include modifications and equivalents of the features and concepts described herein.

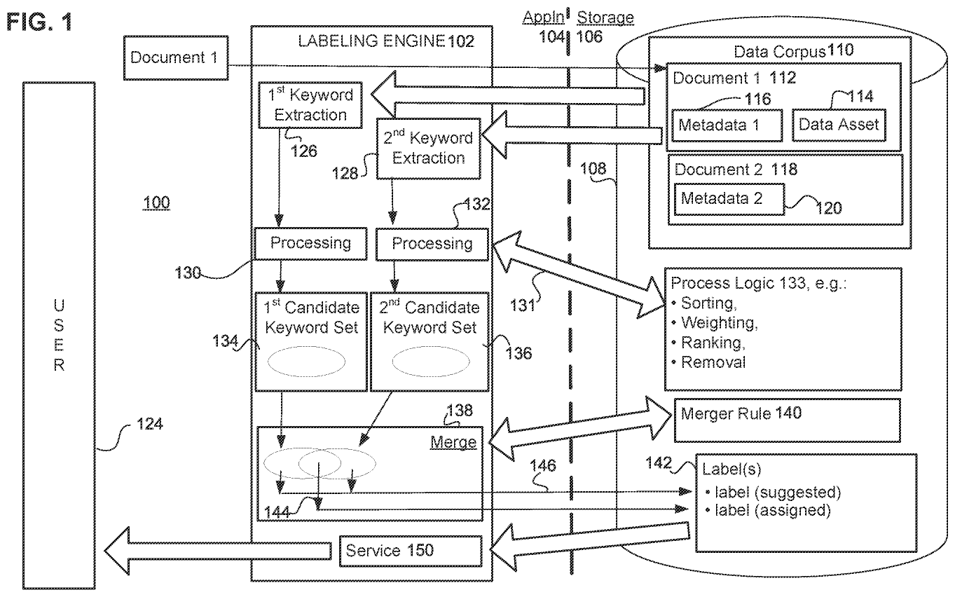

FIG. 1 shows a simplified view of an example system that is configured to implement labeling of data assets according to an embodiment. Specifically, system 100 comprises a labeling engine 102 that is present in an application layer 104.

The application overlies a storage layer 106 comprising a non-transitory computer readable storage medium 108 that includes a data corpus 110. The data corpus comprises a first document 112 including a data asset 114 and first metadata 116. Possible examples of a data asset and first metadata could be a database table and name of that database table, respectively. The data corpus further comprises a second document 118 that includes second metadata 120.

The labeling engine is configured to receive and store the first document in the document corpus. In order to assign a label to the data asset, the labeling engine executes a first keyword extraction procedure 126 upon the data corpus. One possible example of such a first keyword extraction procedure could be based upon TF-IDF.

The labeling engine is also configured to execute a different, second keyword extraction procedure 128 upon at least the first document. One possible example of such a second keyword extraction procedure could be the Yet Another Keyword Extraction (YAKE) procedure in modified form, as described in the example.

The results of executing both keyword extraction procedures are then subject to respective processing 130, 132 by referencing 131 process logic 133 to create respective 1st and 2nd candidate keyword sets 134, 136 respectively. According to one possible example, where the 1st keyword extraction procedure comprises TF-IDF the processing may involve a weighting. Other processing is discussed further below.

Next, the 1st candidate keyword set and the 2nd candidate keyword set are evaluated according to a merge 138 technique referencing a merger rule 140, to produce label(s) 142. The label(s) are then stored.

In one embodiment, the merge technique assigns 144 a label to the data asset appearing in both the 1st and 2nd candidate keyword sets, while recommending 146 a label to the data asset appearing in only one of the 1st and 2nd keyword sets.

Then, based upon operation of service 150, the data asset label(s) are retrieved from storage and communicated to the user for their review.

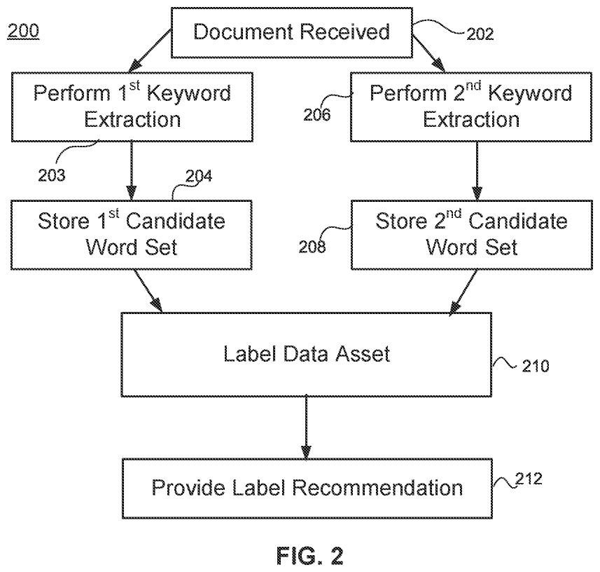

FIG. 2 is a flow diagram of a method 200 according to an embodiment. At 202, a first keyword extraction procedure is performed upon first metadata and second metadata of a data corpus to determine a first set of candidate words for the data asset. At 204 the first set of candidate words are stored in a non-transitory computer readable storage medium.

At 206, a second keyword extraction procedure is performed upon the first metadata to determine a second set of candidate words for the data asset. At 208, the second set of candidate words is stored in the non-transitory computer readable storage medium.

At 210, the data asset is labeled with a keyword appearing in both the first set of candidate words and the second set of candidate words. At 212, a recommendation to label the data asset with a keyword appearing in only one of the first set of candidate words or the second set of candidate words, is provided.

Further details regarding data asset labeling according to various embodiments, are now provided in connection with the following example. In this particular example, data asset labeling is implemented through a combination of a (weighted) TF-IDF procedure, as well as an (expanded) Yet Another Keyword Extractor (YAKE) procedure.

### EXAMPLE

This example describes a method for automatic label extraction and label recommendation, based on data asset metadata. This example combines two different approaches in order to provide improved results.

Specifically, the YAKE procedure expanded to also consider word span, offers desirable results in considering a single document. Moreover, the weighted TF-IDF procedure considers not only a single document, but also a full dataset (which includes more than a single document).

The weighted TF-IDF procedure is used to calculate a first tag pre-result. The expanded YAKE procedure is used to calculate a second tag pre-result.

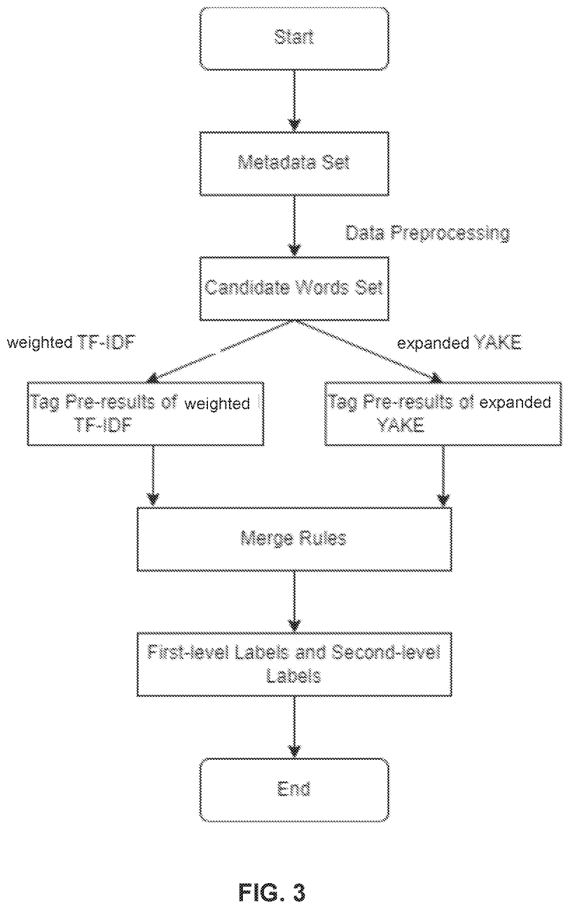

After calculation of the first tag pre-result, and calculation of the second tag pre-result, based upon merging rules the two pre-results are combined to generate first-level labels and second-level labels. FIG. 3 shows a simplified process flow according to the exemplary embodiment.
1) Preprocess data for metadata information, stop words filter, segment words, and generate candidate words set.
2) Tag pre-results are calculated by improved TF-IDF procedure and sort them.
3) Tag pre-results are calculated by improved YAKE procedure and sort them.
4) Use merge rules to combine generated tag pre-results to get first-level labels and second-level labels as results.

Details regarding the merge rules of this example are now described. First, compare the tag pre-result of improved TF-IDF procedure with the tag pre-result of improved YAKE procedure.

If label A appears in both label pre-results, then A should be placed into the first-level labels. If label A appears in only one of label pre-results, then A should be placed into the second-level labels.

Note: the first-level label is the automatically extracted label. It will be automatically tagged to the data asset.

The secondary labels are the recommended labels. When user adds labels, the secondary labels will be recommended (but not binding) to the user.

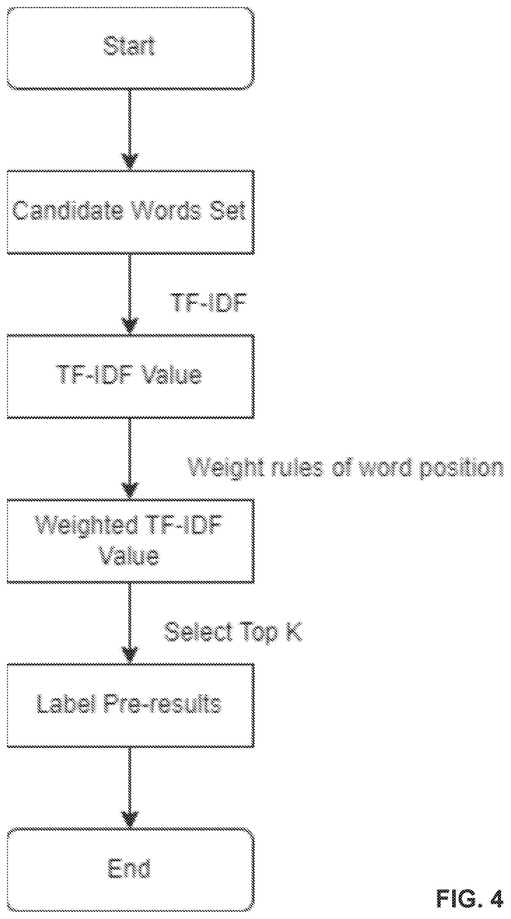

Details regarding the weighted TF-IDF procedure are shown in the simplified flow diagram of FIG. 4.
1) TF-IDF values of candidate words are calculated by the TF-IDF procedure.
2) Weighted TF-IDF values of candidate words are calculated by weighting rules, which may be ranked in descending order.
3) Select Top K weighted TF-IDF values as the label pre-results. If the weighted TF-IDF values are same, keep all of them.

The following table provides details for weighting rules of words position according to this particular example.

| Words Position | Weight |
|---|---|
| Table Name | 0.3 |
| Column Name | 0.2 |
| Description | 0.1 |

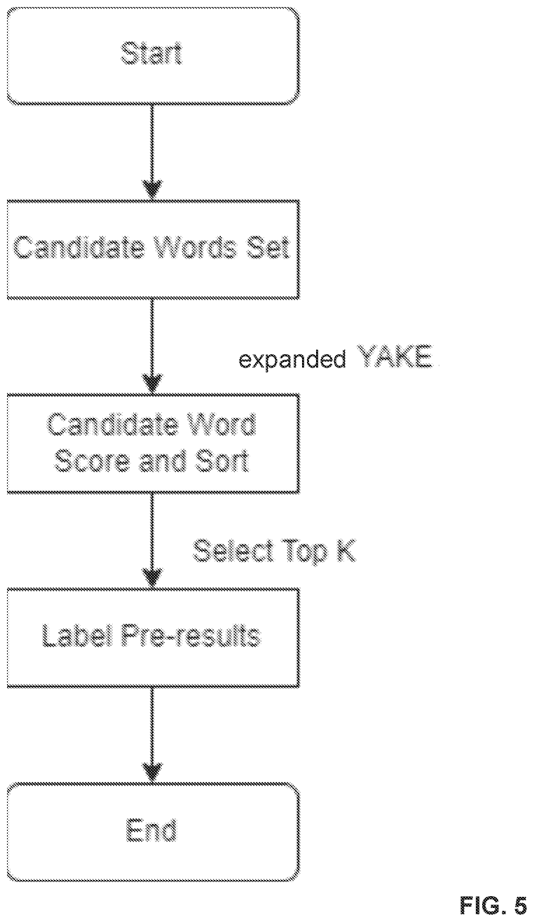

Details regarding the expanded YAKE procedure are shown in the simplified flow diagram of FIG. 5.
1) The improved YAKE values of candidate words are calculated by improved YAKE procedure and sort them.
2) Select Top K improved YAKE values as the label pre-results. If the improved YAKE values are same, keep all of them.

The standard YAKE procedure has the following five (5) dimensions:
1. capital term,
2. word position,
3. word frequency,
4. context relation, and
5. word occurrence frequency in sentences.

To these dimensions, this exemplary embodiment adds a sixth (6) dimension:
6. word span
   Word span refers to the distance between the first and last occurrence of a word or phrase in the text. The larger the word span, the more important the word in the text (and can reflect the theme of the text).

The formula for calculating the span of a word is below:

$${span}_{i} = \frac{{last}_{i} - {first}_{i} + 1}{sum}$$

Here, lastᵢ denotes the last occurrence of word i in the text. The first term denotes the first occurrence of word i in the text. The sum term denotes the total number of words in the text.

The current example is based upon the sales data set of a company that sells bikes. The sales data set as a whole includes thirty-four (34) tables (including, e.g., Addresses, BusinessPartners, CostCenter, Countries, SalesOrders, others) and also related metadata.

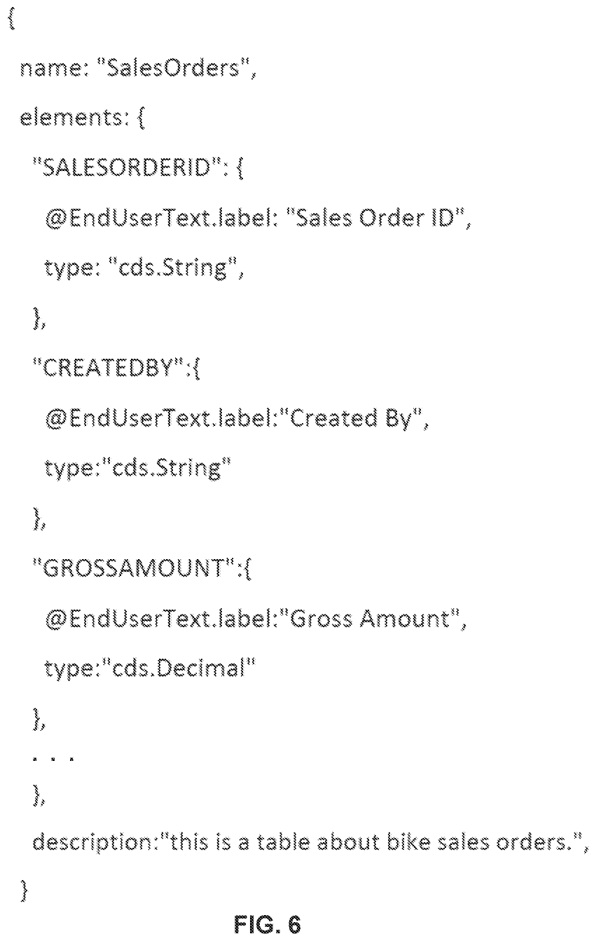

Simplified metadata of the SalesOrders table is shown in FIG. 6. The current exemplary embodiment references metadata of the SalesOrders table, in order to automatically extract labels and provide recommended labels about that table.

Following data preprocessing, the following set of candidate word is obtained:
[“Sale”, “Order”, “Fiscal”, “Note”, “Partner”, “Org”, “Currency”, “GROSSAMOUNT”, “NETAMOUNT”, “TAXAMOUNT”, “Lifecycle”, “Billing”, “Delivery”, “Bike”].

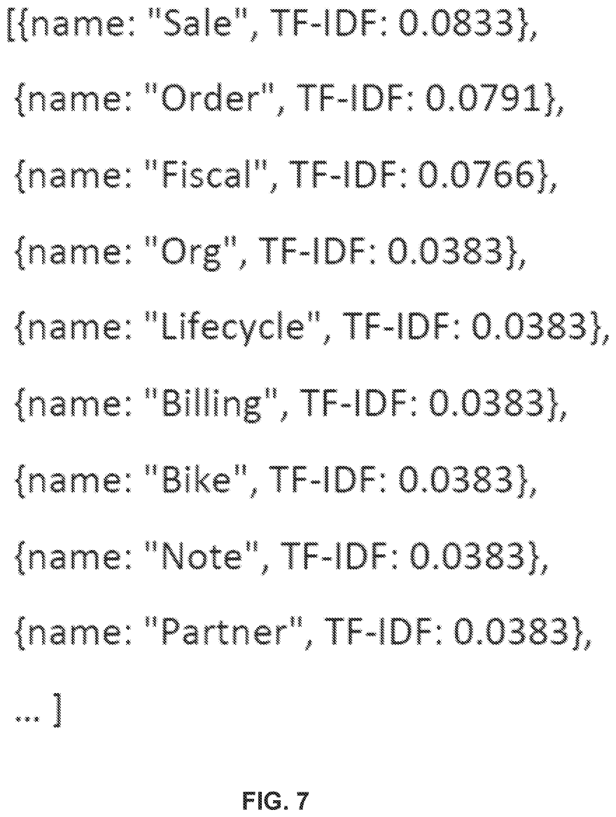

The weighted TF-IDF procedure is used to get the TF-IDF values of candidate words, and then to perform a descending sort of those values. The original (unweighted) TF-IDF values are shown in FIG. 7.

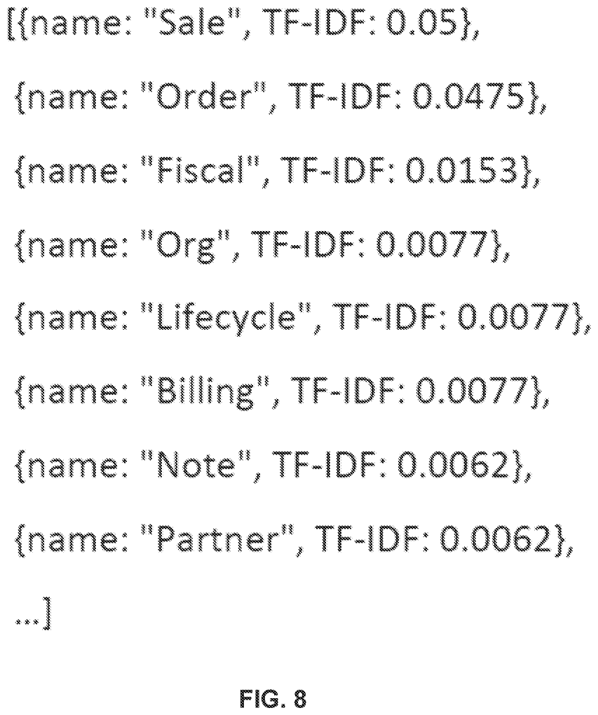

Weighted TF-IDF values of candidate words are calculated according to the weighting rules in the table shown above (considering word position). The resulting weighted TF-IDF values are shown in FIG. 8.

Then, the top six (6) weighted TF-IDF values are selected as the tag pre-results. The improved TF-IDF tag pre-results are shown below:
['sale', ‘order’, Fiscal', ‘Org’, ‘Lifecycle’, ‘Billing’].
   Note that the candidate word: “Bike” is not included.

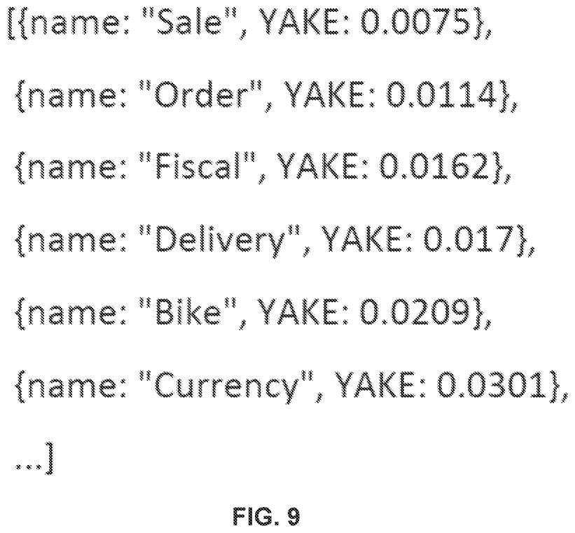

In parallel, the improved YAKE procedure is used to compute the YAKE values of candidate words. The sorted YAKE values of candidate words are shown in FIG. 9.

Then, the top six (6) keywords are selected as the tag pre-result. The YAKE tag pre-results are given below:
['sale', ‘order’, ‘Fiscal’, ‘Delivery’, ‘Bike’, ‘Currency’].

The tag pre-results of the weighted TF-IDF procedure and of the expanded YAKE procedure are merged according to the merge rules. This results in the following first-level labels (included in both sets):
['sale', ‘order’, ‘Fiscal’]
   These first-level data asset labels are automatically adopted.

We get the following second-level labels (included in only one of the sets):
['Org', ‘Lifecycle’, ‘Billing’, ‘Delivery’, ‘Bike’, ‘Currency’]
   These second-level data asset labels are offered as suggestions.

Performing data asset labeling according to embodiments, may offer one or more benefits. Specifically, one possible benefit is reduction in variability. That is, because the labeling is performed according to a fixed procedure, results are reproducible and not dependent upon the exercise of human discretion.

The use of two procedures (rather than a single procedure) can offer certain benefits. One benefit is a higher accuracy result that considers more inputs. Two sets of labels for data assets are obtained (rather than only a single set).

A second benefit is the ability to provide label recommendations. That is, where a keyword appears in only one of the two procedures, then that proposed asset label can be offered as a (second-level) suggestion. Rather than being automatically adopted or ignored completely, the user is able to exercise his or her experience and discretion in order to assess the suitability of the proposed label.

Embodiments are not limited to the particular two specific procedures of this example. Examples of other key phrase extraction algorithms that could be used, include but are not limited to:
Rapid Automatic Keyword Extraction (RAKE),
Linear Discriminant Analysis (LDA),
KeyBert,
TextRank; and
others.

Returning now to FIG. 1, there the particular embodiment is depicted with the labeling engine as being located outside of the database. However, this is not required.

Rather, alternative embodiments could leverage the processing power of an in-memory database engine (e.g., the in-memory database engine of the HANA in-memory database available from SAP SE), in order to perform one or more various functions as described above.

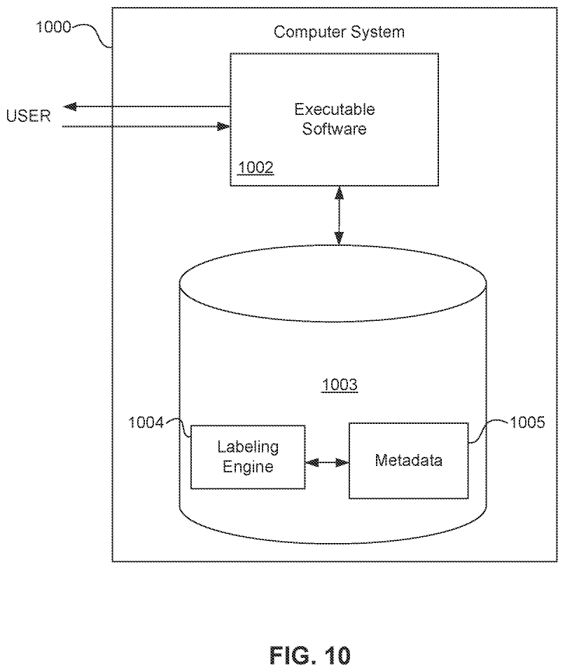

Thus FIG. 10 illustrates hardware of a special purpose computing machine configured to perform data asset labeling according to an embodiment. In particular, computer system 1000 comprises a processor 1002 that is in electronic communication with a non-transitory computer-readable storage medium comprising a database 1003. This computer-readable storage medium has stored thereon code 1005 corresponding to a labeling engine. Code 1004 corresponds to metadata. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1. Computer implemented systems and methods comprising:
receiving a first document including a data asset and first metadata;
storing the first document in a data corpus also including a second document and second metadata;
performing a first keyword extraction procedure upon the first metadata and the second metadata to determine a first set of candidate words for the data asset;
storing the first set of candidate words in a non-transitory computer readable storage medium;
performing a second keyword extraction procedure upon the first metadata to determine a second set of candidate words for the data asset;
storing the second set of candidate words in the non-transitory computer readable storage medium;
labeling the data asset with a keyword appearing in both the first set of candidate words and the second set of candidate words; and
providing a recommendation to label the data asset with a keyword appearing in only one of the first set of candidate words or the second set of candidate words.

Example 2. The computer implemented systems or methods of Example 1 wherein the first keyword extraction procedure comprises Term Frequency-Inverse Document Frequency (TF-IDF) that assigns a weight to each of the first set of candidate words.

Example 3. The computer implemented systems or methods of Example 2wherein:
the first metadata comprises a table; and
the weight is assigned based upon appearance of a candidate word from the first set of candidate words, in a name of the table.

Example 4. The computer implemented systems or methods of Example 2wherein:
the first metadata comprises a table; and
the weight is assigned based upon appearance of a candidate word from the first set of candidate words, in a name of a column of the table.

Example 5. The computer implemented systems or methods of Example 2wherein:
the first metadata comprises a description; and
the weight is assigned based upon appearance of a candidate word from the first set of candidate words, in the description.

Example 6. The computer implemented systems or methods of Examples 2, 3, 4, or 5 further comprising:
ordering the first set of candidate words in a rank according to the weight; and
removing some candidate words from the first set of candidate words based upon the rank.

Example 7. The computer implemented systems or methods of Examples 1, 2, 3, 4, 5, or 6 wherein the second keyword extraction procedure considers a word span.

Example 8. The computer implemented systems or methods of Example 7 wherein the second keyword extraction procedure further considers one or more of:
a capital term,
a word position,
a word frequency,
a context relation, and
a word occurrence frequency in sentences.

Example 9. The computer implemented systems or methods of Examples 1, 2, 3, 4, 5, 6, 7, or 8 wherein:
the non-transitory computer readable storage medium comprises an in-memory database in which the data corpus is stored; and
an in-memory database engine of the in-memory database performs the first keyword extraction procedure, and performs the second keyword extraction procedure.

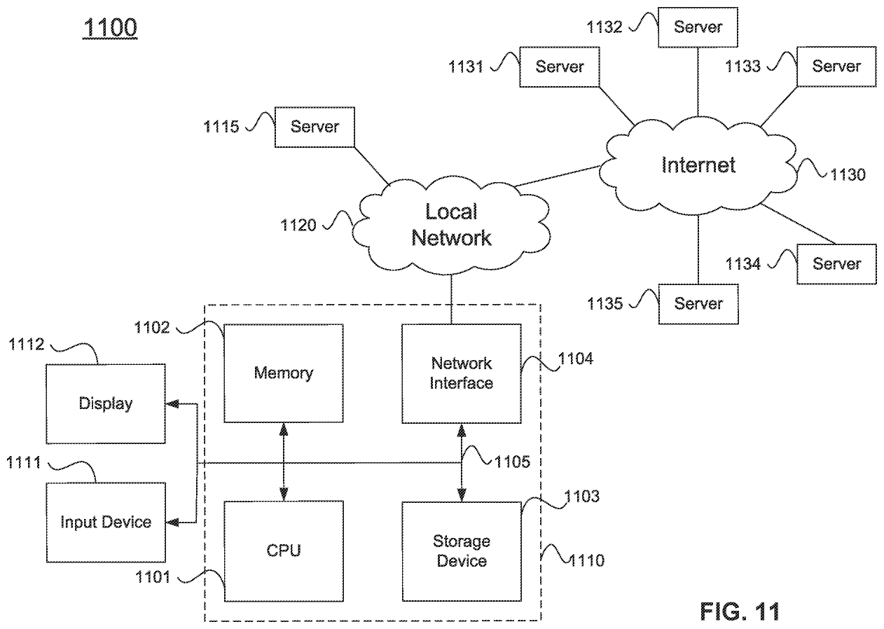

An example computer system 1100 is illustrated in FIG. 11. Computer system 1110 includes a bus 1105 or other communication mechanism for communicating information, and a processor 1101 coupled with bus 1105 for processing information. Computer system 1110 also includes a memory 1102 coupled to bus 1105 for storing information and instructions to be executed by processor 1101, including information and instructions for performing the techniques described above, for example. This memory may also be used for storing variables or other intermediate information during execution of instructions to be executed by processor 1101. Possible implementations of this memory may be, but are not limited to, random access memory (RAM), read only memory (ROM), or both. A storage device 1103 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 1103 may include source code, binary code, or software files for performing the techniques above, for example. Storage device and memory are both examples of computer readable mediums.

Computer system 1110 may be coupled via bus 1105 to a display 1112, such as a Light Emitting Diode (LED) or liquid crystal display (LCD), for displaying information to a computer user. An input device 1111 such as a keyboard and/or mouse is coupled to bus 1105 for communicating information and command selections from the user to processor 1101. The combination of these components allows the user to communicate with the system. In some systems, bus 1105 may be divided into multiple specialized buses.

Computer system 1110 also includes a network interface z04 coupled with bus z05. Network interface 1104 may provide two-way data communication between computer system 1110 and the local network 1120. The network interface 1104 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 1104 sends and receives electrical, electromagnetic, or optical signals that carry digital data streams representing various types of information.

Computer system 1110 can send and receive information, including messages or other interface actions, through the network interface 1104 across a local network 1120, an Intranet, or the Internet 1130. For a local network, computer system 1110 may communicate with a plurality of other computer machines, such as server 1115. Accordingly, computer system 1110 and server computer systems represented by server 1115 may form a cloud computing network, which may be programmed with processes described herein. In the Internet example, software components or services may reside on multiple different computer systems 1110 or servers 1131-1135 across the network. The processes described above may be implemented on one or more servers, for example. A server 1131 may transmit actions or messages from one component, through Internet 1130, local network 1120, and network interface 1104 to a component on computer system 1110. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method comprising:
receiving a first document including a data asset and first metadata;
storing the first document in a data corpus also including a second document and second metadata;
performing a first keyword extraction procedure upon the first metadata and the second metadata to determine a first set of candidate words for the data asset;
storing the first set of candidate words in a non-transitory computer readable storage medium;
performing a second keyword extraction procedure upon the first metadata to determine a second set of candidate words for the data asset;
storing the second set of candidate words in the non-transitory computer readable storage medium;
labeling the data asset with a keyword appearing in both the first set of candidate words and the second set of candidate words; and
providing a recommendation to label the data asset with a keyword appearing in only one of the first set of candidate words or the second set of candidate words.

2. A method as in claim 1 wherein the first keyword extraction procedure comprises Term Frequency-Inverse Document Frequency (TF-IDF) that assigns a weight to each of the first set of candidate words.

3. A method as in claim 2 wherein:
the first metadata comprises a table; and
the weight is assigned based upon appearance of a candidate word from the first set of candidate words, in a name of the table.

4. A method as in claim 2 wherein:
the first metadata comprises a table; and
the weight is assigned based upon appearance of a candidate word from the first set of candidate words, in a name of a column of the table.

5. A method as in claim 2 wherein:
the first metadata comprises a description; and
the weight is assigned based upon appearance of a candidate word from the first set of candidate words, in the description.

6. A method as in claim 2 further comprising:
ordering the first set of candidate words in a rank according to the weight; and
removing some candidate words from the first set of candidate words based upon the rank.

7. A method as in claim 1 wherein the second keyword extraction procedure considers a word span.

8. A method as in claim 7 wherein the second keyword extraction procedure further considers one or more of:
a capital term,
a word position,
a word frequency,
a context relation, and
a word occurrence frequency in sentences.

9. A method as in claim 1 wherein:
the non-transitory computer readable storage medium comprises an in-memory database in which the data corpus is stored; and
an in-memory database engine of the in-memory database,
performs the first keyword extraction procedure, and
performs the second keyword extraction procedure.

10. A non-transitory computer readable storage medium embodying a computer program for performing a method, said method comprising:
receiving a first document including a data asset and first metadata;
storing the first document in a data corpus also including a second document and second metadata;
performing a weighted Term Frequency-Inverse Document Frequency (TF-IDF) keyword extraction procedure upon the first metadata and the second metadata to determine a first set of candidate words for the data asset, the weighted TF-IDF assigning a weight to each of the first set of candidate words;
storing the first set of candidate words in a non-transitory computer readable storage medium;
performing a different keyword extraction procedure upon the first metadata to determine a second set of candidate words for the data asset;
storing the second set of candidate words in the non-transitory computer readable storage medium;
labeling the data asset with a keyword appearing in both the first set of candidate words and the second set of candidate words; and
providing a recommendation to label the data asset with a keyword appearing in only one of the first set of candidate words or the second set of candidate words.

11. A non-transitory computer readable storage medium as in claim 10 wherein:
the first metadata comprises a table; and
the weight is assigned based upon appearance of a candidate word from the first set of candidate words, in a name of the table.

12. A non-transitory computer readable storage medium as in claim 10 wherein:
the first metadata comprises a table; and
the weight is assigned based upon appearance of a candidate word from the first set of candidate words, in a name of a column of the table.

13. A non-transitory computer readable storage medium as in claim 10 wherein:
the first metadata comprises a description; and
the weight is assigned based upon appearance of a candidate word from the first set of candidate words, in the description.

14. A non-transitory computer readable storage medium as in claim 10 wherein the second keyword extraction procedure considers one or more of:
a capital term,
a word position,
a word frequency,
a context relation,
a word occurrence frequency in sentences, and
a word span.

15. A computer system comprising:
one or more processors;
a software program, executable on said computer system, the software program configured to cause an in-memory database engine of an in-memory database to:
store in the in-memory database, a data corpus comprising a first document including a data asset and first metadata, and a second document including second metadata;
perform a first keyword extraction procedure upon the first metadata and the second metadata to determine a first set of candidate words for the data asset;
store the first set of candidate words in the in-memory database;
perform a second keyword extraction procedure upon the first metadata to determine a second set of candidate words for the data asset;
store the second set of candidate words in the non-transitory computer readable storage medium;
label the data asset with a keyword appearing in both the first set of candidate words and the second set of candidate words; and
provide a recommendation to label the data asset with a keyword appearing in only one of the first set of candidate words or the second set of candidate words.

16. A computer system as in claim 15 wherein the first keyword extraction procedure comprises Term Frequency-Inverse Document Frequency (TF-IDF) that assigns a weight to each of the first set of candidate words.

17. A computer system as in claim 16 wherein the weight is assigned based upon appearance of a candidate word from the first set of candidate words in at least one of:
a table name;
a table column name; and
a description.

18. A computer system as in claim 16 wherein the second keyword extraction procedure considers one or more of:
a capital term,
a word position,
a word frequency,
a context relation,
a word occurrence frequency in sentences, and
a word span.

19. A computer system as in claim 16 wherein the in-memory database engine is further configured to:
order the first set of candidate words in a rank according to the weight; and
remove some candidate words from the first set of candidate words based upon the rank.

20. A computer system as in claim 15 wherein the in-memory database engine is further configured to:
order the second set of candidate words in a rank; and
remove some candidate words from the second set of candidate words based upon the rank.
